(19) United States
(12) Patent Application Publication
(10) Pub. No.: US 2022/0065649 A1
(43) Pub. Date: Mar. 3, 2022

(54) HEAD-UP DISPLAY SYSTEM

(71) Applicant: VESTEL ELEKTRONIK SANAYI VE TICARET A.S., Manisa (TR)

(72) Inventor: Muhammet Kursat SARIARSLAN, Manisa (TR)

(73) Assignee: VESTEL ELEKTRONIK SANAYI VE TICARET A.S., Manisa (TR)

(21) Appl. No.: 17/423,732

(22) PCT Filed: Jan. 18, 2019
(86) PCT No.: PCT/EP2019/051229

§ 371 Date: Jul. 16, 2021

(51) Int. Cl. G01C 21/36

(52) U.S. Cl. CPC G01C 21/365; G01C 21/3652; G01C 21/3691; G01C 21/3644

(57) ABSTRACT

A head-up display system and a method involving a head-up display are described for identifying and displaying information about a part of a road that is not visible to a driver. The head-up display system for a vehicle may comprise: a projector configured to project information regarding a course of a road onto a transparent plane; and a processor configured to analyze an image of a road ahead of the vehicle, the image provided by a camera, and determine the road course based on the input of the camera; analyze navigational information regarding the position of the vehicle on a map comprising the road, the navigational information provided by a navigation system, and determine the road course based on the input of the navigation system; and match the road course determined by the input of the camera and the road course determined by the input of the navigation system.

### CROSS-REFERENCE TO RELATED APPLICATION

This application is the U.S. national phase of PCT Application No. PCT/EP2019/051229 filed on Jan. 18, 2019, the disclosure of which is incorporated in its entirety by reference herein.

### TECHNICAL FIELD

The disclosure relates to a head-up display system 100 and a method involving the head-up display system 100 for identifying and displaying information about a part of a road that is not visible to a driver.

### BACKGROUND

Current navigation systems which provide their directions in a visible form usually display the information via a separate panel or use a head-up display. The information presented on the head-up display is usually rather limited and consists of simple icons, concise textual information or/and arrows to provide navigational information to the driver. When a driver views navigational information on a separate panel of a navigational system 100 his attention is drawn away from the situation on the road ahead of him at least for a short moment which may lead to dangerous situations. Therefore, it would be desirable that the driver is informed about potentially dangerous situations or/and the exact upcoming road course in an improved way.

Document DE102004048347A1 discloses a driving aid device for a motor vehicle. The device comprises a navigation device, an imaging sensor, an image reproduction device and a controller, whereby at least the navigation device, the imaging sensor and the image reproduction device are connected to the controller. The controller processes the images recorded by the imaging sensor for recognition of the carriageway and the road trajectory and determines at least the subsequent road trajectory lying outside the field of view of the imaging sensor from the road map data provided for the navigation device in order to generate a prediction of the road trajectory in the form of a positionally-accurate display on the image reproduction device by integration of both forms of information. Said display may be accurately overlaid on the view of the traffic and driving situation visible to the driver in a positionally and perspectively accurate manner.

Document US2016003636A1 discloses a system which includes a lane marking manager determining a first boundary line, a second boundary line, and a centerline of a current lane of travel. The system also includes a confidence level determiner assigning a first confidence level to the first boundary line, a second confidence level to the second boundary line, and a third confidence level to the centerline. Further, the system includes a user interface outputting representations of the first boundary line, the second boundary line, and the centerline based, at least in part, on the first confidence level, the second confidence level, and the third confidence level.

DocumentUS2018089899A1 discloses an AR system that leverages a pre-generated 3D model of the world to improve rendering of 3D graphics content for AR views of a scene, for example an AR view of the world in front of a moving vehicle. By leveraging the pre-generated 3D model, the AR system uses a variety of techniques to enhance the rendering capabilities of the system. The AR system obtains pre-generated 3D data (e.g., 3D tiles) from a remote source (e.g., cloud-based storage), and uses this pre-generated 3D data (e.g., a combination of 3D mesh, textures, and other geometry information) to augment local data (e.g., a point cloud of data collected by vehicle sensors) to determine much more information about a scene, including information about occluded or distant regions of the scene, than is available from the local data.

### SUMMARY

Therefore, it is an object of the present disclosure to provide an improved system overcoming the drawbacks of the prior art.

Disclosed is a Head-Up display system 100 for a vehicle comprising:

a projector 104 and a transparent plane 105 in the field of view of a driver, configured to project information regarding the course of a road onto the transparent plane 105; and a processor 103 configured to:

analyze an image of a road ahead of a vehicle, the image provided by a camera 101, and determine the road course based on the input of the camera 101;

analyze navigational information regarding the position of the vehicle on a map comprising the road, the navigational information provided by a navigation system 102, and determine the road course based on the input of the navigation system 102;

match the road course determined by the input of the camera 101 and the road course determined by the input of the navigation system 102;

determine the part of the road course determined by the input of the navigation system 102 not captured by the camera 101;

calculate graphical information 306 on the part of the road course ahead not captured by the camera 101; and

project the calculated graphical information 306 regarding the part of the road course ahead not captured by the camera 101 via the projector 104 starting from the end of the road course ahead not captured by the camera 101, thereby providing graphical information 306 regarding the non-visible part of the road ahead onto the transparent plane 105.

The road course determined on the input of the camera 101 and the road course determined on the input of the navigation system 102 may comprise information regarding the roadsides of the road, the road lane 304 used by the vehicle, or/and the medial strip 303 of a road.

The projected graphical information 306 may be in the form of continuous or non-continuous lines indicating the roadsides of the road or a strip indicating the road or a road lane 304 of the road.

The projected graphical information 306 may be in a color different from the colors visible in the field of view of the driver.

The processor 103 may be further configured to determine that the part of the road ahead not captured by the camera 101 contains a cause of danger and provide an alarm to the driver.

The cause of danger may be a sharp or abrupt turning, a traffic light, or/and a narrowing of the road.

The alarm may be a visible, haptic or acoustic alarm.

The alarm may be indicated by a predetermined color and/or by a flashing of the projected graphical information 306.

The system 100 may further comprise the camera 101 configured to capture an image of a road ahead of a vehicle.

The system 100 may further comprise the navigation system 102 configured to determine the position of a vehicle on a map comprising road lanes 304.

Disclosed is also a computer implemented method for providing graphical information 306 on the non-visible part of a road ahead in the field of view of the driver with the head display system 100 described above comprising:

analyzing an image of a road ahead of a vehicle, wherein the image is provided by a camera 101 and determine the road course;

analyzing navigational information regarding the position of the vehicle on a map comprising the road, the navigational information provided by a navigation system 102, and determine the road course;

matching the road course determined by the input of the camera 101 and the road course road course determined on the input of the navigation system 102;

determining the part of the road course determined by the input of the navigation system 102 not captured by the camera 101;

calculating graphical information 306 regarding the part of the course of the road ahead not captured by the camera 101 and starting from the end of the road ahead not captured by the camera 101; and

projecting the calculated graphical information 306 on the part of the course of the road ahead not captured by the camera 101 via the projector 104 onto the transparent plane 105 starting from the end of the road ahead not captured by the camera 101.

Disclosed is also a data carrier comprising instructions for a processing system 100, which when executed by the processing system 100, cause the computer to perform the computer implemented method describe above.

Disclosed is also a processing system 100 comprising the data carrier described above.

The processing system 100 may be an Application-Specific Integrated Circuit, ASIC, a Field-programmable gate arrays, FPGA, or a general purpose computer.

Disclosed is also a vehicle comprising the head-up display system 100 or the processing system 100 described above.

### BRIEF DESCRIPTION OF THE DRAWINGS

FIG. 1 illustrates a head-display system 100 as described in the present disclosure.

FIG. 2 illustrates a method as described in the present disclosure.

FIG. 3 illustrates the view of a driver on the course of a road ahead containing obstacles 305 preventing him from the entire course of the road ahead of him without the system 100 of the disclosure.

FIG. 4 illustrates the view of a driver on the course of a road ahead containing obstacles 305 preventing him from the entire course of the road ahead of him without the system 100 of the disclosure. The system 100 provides graphical information 306 on the non-visible part of the road to the driver.

### DETAILED DESCRIPTION

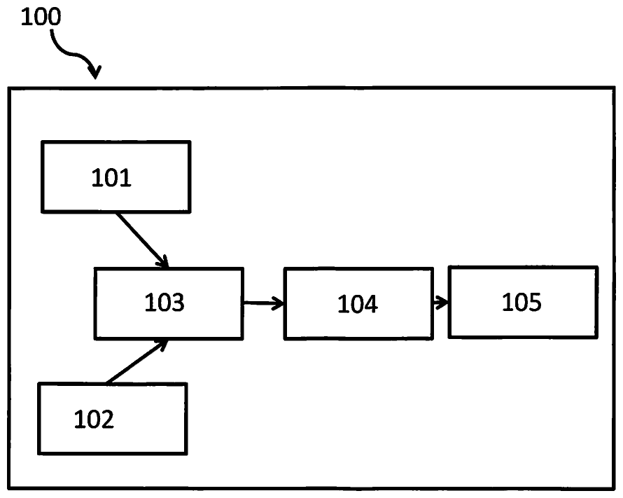

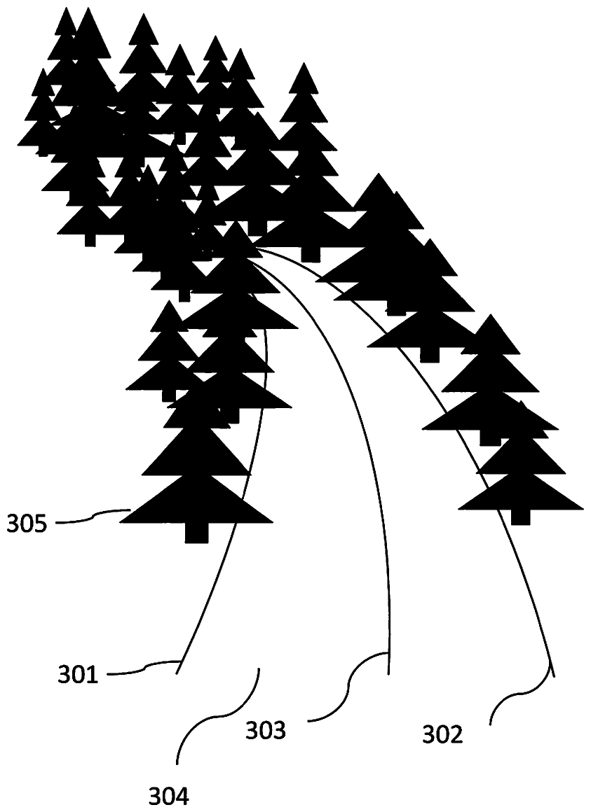

Disclosed is a system 100 for a vehicle as illustrated in FIG. 1. FIG. 3 illustrates the view of a driver of a vehicle through the windshield without the system 100 of FIG. 1.

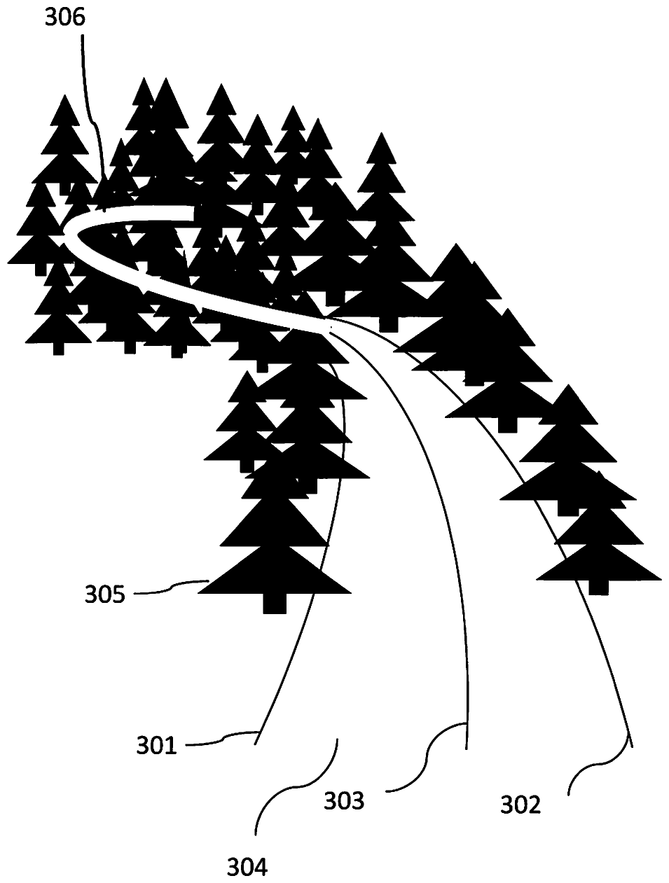

FIG. 4 illustrates the view of a driver of a vehicle through the windshield with the system 100 illustrated in FIG. 1. The system 100 has the advantage that it visualizes that part of a road or track that is invisible to the driver from his point of view, i.e., in the field of the view of the driver, by calculating graphical information 306 which is projected into the field of view of the driver, e.g., onto a transparent plane 105 in the field of the view of the driver integrated into or positioned in front of the windshield of the vehicle.

The system 100 can be considered to be a head-up display system 100 or a system 100 that is integrated into a head-up display system 100. The system 100 by a processor 103 analyses an input received and provided by a camera 101. The input is at least one image by a camera 101. The camera 101 is capable of capturing an image of the field of view that is visible in the direction into which the vehicle is driving, i.e., usually the forward direction of the car, but is also possible that the camera 101 captures at least one image in the direction reverse to the forward direction of the car. The input can consist of at least one image or a (successive) series of images. Capturing a series of images allows to continuously update the calculated graphical information 306. The processor 103 after analyzing the at least one image of a road ahead of the vehicle identifies the road course visible to the camera 101 and thus the part of the road visible to the driver.

Object recognition analysis can be performed on the images received by the camera 101 to determine the presence and course of a road. For example, the processor 103 may be configured to detect the road by: a color transition between the road and its surroundings, guide posts on the left and/or right side of the road, lane lines, and/or medial lines.

The camera 101 may be replaced or supplemented by a laser detection and ranging, LIDAR, or/and radio detection and ranging, RADAR system 100 to provide information on the distance between the vehicle and the road ahead, i.e., the course of the road in three-dimensional space. The camera 101 may also consist of a stereo camera 101 for determining a three-dimensional image of the road ahead of the vehicle to provide information on the distance between the vehicle and the road ahead, i.e., the course of the road in three-dimensional space. Based on the knowledge of the distance of the vehicle to the road a three-dimensional representation for the road course can be determined.

Preferably concurrently, the system 100 is configured to also receive navigational information regarding the position of the vehicle on a map. The map, which is stored in an electronic memory and comprises at least positional data in two-dimensional or three-dimensional form on the course of roads or tracks, provides information on the road course as stored in the navigational system 100 and thus it can be identified on which road a vehicle is driving and which course this road has.

The system 100 is further configured to match the road course determined from the camera 101-input with the road course determined from the input of the navigational system 100. Matching visible objects with positional data is a known technique in the field of augmented reality and any suitable algorithm may be used for achieving this task. For example, for this tasks both inputs are transformed into the same spatial reference system 100 which can be spatial reference system 100 of the analyzed image, the spatial reference system 100 provided by the navigational system 100 or a third reference system 100. The navigational input is either already provided in the form of three-dimensional spatial data or transformed into the form of three-dimensional spatial data by the system 100.

The system 100 is further configured to determine the part of the road course determined from the input of the navigational system 100 that is not captured by the camera 101. This is the part of the road that is not visible for the camera 101 or the driver. It may not be visible because it is occluded by objects like, trees, hills, mountains, buildings, tunnels which are positioned at or in front of an upcoming curve. In addition, the part of the road may not be visible because the vehicle is approaching a hilltop.

The system 100 is further configured to calculate graphical information 306 for the system 100 which can be projected onto the transparent plane 105 representing the part of the road course determined from the input of the navigational system 100 that is not captured by the camera 101 (see FIG. 4). In other words, the system 100 (via the processor 103) is configured to calculate a representation of the road course not visible to the driver which can be projected onto the transparent plane 105 in the field of view of the camera 101. In this way, the field of view of the driver is overlaid with a representation of the non-visible part of the road, which is aligned to the visible road.

The graphical information on the nonvisible part of the road course may seamlessly or almost seamlessly connect the visible road with a representation of the non-visible road ahead. The system can also be configured that only a limited part of the non-visible part of the road is displayed, i.e., having a length corresponding to the length of the part of the road in reality of less than 10 km, 5 km, 3 km, 2 km, 1 km, 500 m, 200 m.

The determined road course from the camera 101 input and the road course from the navigation system 102 can comprise information on the roadsides of the road, the road lane 304 used by the vehicle, or/and the medial strip 303 of a road. Thus, the representation of the non-visible road ahead can also include this information.

Accordingly, the projected graphical information 306 can be in the form of continuous or non-continuous lines indicating the roadsides of the road or a strip indicating the road or a road lane 304 of the road.

The projected graphical information 306 can be in a color different from the colors visible in the field of view of the driver. In this way, it is easier for the driver to identify the non-visible part of the road against the surroundings. However, it is also contemplated that the graphical information 306 is provided in the same or almost the same color and/or texture of the road to avoid a distraction of the driver from the road by the overlaid graphical information 306.

The processor 103 can be further configured to determine that the part of the road ahead not captured by the camera 101 contains a cause of danger and provide an alarm to the driver.

The cause of danger can be a sharp or abrupt turning, a traffic light, or/and a narrowing of the road. The system 100 may identify a cause of danger also by the data input provided by the navigation system 102. For example, the system 100 may be configured to determine a sharp or abrupt terming or a narrowing when the angle of the turning falls under a predetermined value like 100°, 90°, 80° or less, or the width of the non-visible road compared to the width of the visible road falls under a predetermined value like 90%, 80%, 70% or less of the width of the visible road.

The alarm can be a visible, haptic or acoustic alarm. In particular, the alarm can be indicated by the color and/or by a flashing of the projected graphical information 306. For example, the projected graphical information 306 may usually be in a default color, like yellow or blue, and switch to an alarm color like red and additionally or alternatively start flashing.

The system 100 may further comprise the camera 101 or/and any other form of an image capturing device like a LIDAR or RADAR configured to capture an image of a road ahead of a vehicle.

The system 100 may further comprise the navigation system 102 configured to determine the position of a vehicle on a map comprising road lanes 304.

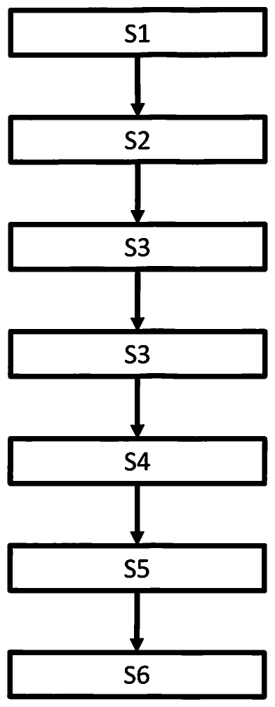

Disclosed is also a method (illustrated in FIG. 2), in particular, a computer implemented method for providing graphical information 306 on the non-visible part of a road ahead in the field of view of the driver with the head display system 100 as described above comprising:
analyzing S1 an image of a road ahead of a vehicle, the image provided by a camera 101 and determine the course of camera 101-based road;
analyzing S2 navigational information on the position of the vehicle on a map comprising the road, the navigational information provided by a navigation system 102, and determine the course of the navigation system 102-based road;
matching S3 the course of camera 101-based road and the course of navigation system 102-based road;
determining S4 the part of the course of the navigation system 102-based road ahead not captured by the camera 101;
calculating S5 graphical information 306 for a head-up display on the part of the course of the road ahead not captured by the camera 101 and starting from the end of the road ahead not captured by the camera 101; and
projecting S6 the calculated graphical information 306 on the part of the course of the road ahead not captured by the camera 101 via the projector 104 starting from the end of the road ahead not captured by the camera 101.

Disclosed is also a data carrier comprising instructions for a processing system 100, which when executed by the processing system 100, cause the computer to perform the method described above.

The system 100 may be implemented on a processing system which may comprise the data carrier described above.

The processing system 100 is not particularly limited and can be an Application-Specific Integrated Circuit, ASIC, a Field-programmable gate arrays, FPGA, or a general purpose computer.

Disclosed is also a vehicle comprising the system 100 described above or the processing system 100 described above.

Thus, a head-up display system and a method involving the head-up display system is described for identifying and displaying information about a part of a road that is not visible to a driver wherein the head-up display system 100 for a vehicle comprises:

a projector 104 and a transparent plane 105 in the field of view of a driver, configured to project information regarding the course of a road onto the transparent plane 105; and a processor 103 configured to:

analyze an image of a road ahead of a vehicle, the image provided by a camera 101, and determine the road course based on the input of the camera 101;

analyze navigational information regarding the position of the vehicle on a map comprising the road, the navigational information provided by a navigation system 102, and determine the road course based on the input of the navigation system 102;

match the road course determined by the input of the camera 101 and the road course determined by the input of the navigation system 102;

determine the part of the road course determined by the input of the navigation system 102 not captured by the camera 101;

calculate graphical information 306 on the part of the road course ahead not captured by the camera 101; and project the calculated graphical information 306 regarding the part of the road course ahead not captured by the camera 101 via the projector 104 starting from the end of the road course ahead not captured by the camera 101, thereby providing graphical information 306 regarding the non-visible part of the road ahead onto the transparent plane 105.

### REFERENCE NUMERALS

100 (Heads-Up Display) System

101 Camera

102 Navigation system

103 Processor

104 Projector

105 transparent plane

301 Left roadside

302 Right roadside

303 Medial strip

304 Road lane

305 Obstacle

306 Graphical information

S1-S6 Method Steps

1. A head-up display system for a vehicle comprising:
a projector and a transparent plane arrangeable in a field of view of a driver, wherein the projector is configured to project information for a road course onto the transparent plane; and
a processor configured to:
analyze an image of a road ahead of a vehicle, the image provided as input by a camera, and determine the road course based on the input of the camera;
analyze navigational information regarding a position of the vehicle on a map comprising the road, the navigational information provided as input by a navigation system, and determine the road course based on the input of the navigation system;
match the road course determined by the input of the camera and the road course determined by the input of the navigation system;
determine a part of the road course determined by the input of the navigation system not captured by the camera;
calculate graphical information regarding the part of the road course ahead not captured by the camera; and
project the calculated graphical information regarding the part of the road course ahead not captured by the camera via the projector-starting from the an end of the road course ahead not captured by the camera, thereby providing graphical information on a non-visible part of the road ahead onto the transparent plane; wherein the processor is further configured to determine that the part of the road course ahead not captured by the camera includes a cause of danger and provide an alarm to the driver.

2. The head-up display system according to claim 1 wherein the road course determined by the input of the camera and the road course determined by the input of the navigation system comprise information on roadsides of the road, a road lane used by the vehicle, and/or a medial strip of the road.

3. The head-up display system according to claim 2 wherein the projected graphical information comprises continuous or non-continuous lines indicating the roadsides of the road or a strip indicating the road or a road lane of the road.

4. The head-up display system according to claim 1 wherein the projected graphical information is in a color different from thc colors visible in the field of view of the driver.

5. (canceled)

6. The head-up display system according to claim 1, wherein the cause of danger comprises a sharp or abrupt turning, a traffic light, and/or a narrowing of the road.

7. The head-up display system according to claim 1, wherein the alarm comprises a visible, haptic or acoustic alarm.

8. The head-up display system according to claim 1, wherein the alarm is indicated by a predetermined color and/or flashing of the projected graphical information

9. The head-up display system according to claim 1, wherein the system further comprises the camera.

10. The head-up display system according to claim 1, wherein the system further comprises the navigation systems.

11. A computer implemented method for providing graphical information on a part of a road ahead that is non-visable in a field of view of a driver, the method comprising:
analyzing an image of a road ahead of a vehicle, the image provided by a camera, and determining a road course;
analyzing navigational information on position of the vehicle on a map comprising the road, the navigational information provided by a navigation system, and determining the road course;
matching the road course determined by input of the camera and the road course determined by input of the navigation system;
determining a part of the road course determined by the input of the navigation system not captured by the camera;
calculating graphical information for a head-up display regarding the part of the road course ahead not captured by the camera and starting from an end of the road ahead not captured by the camera;
projecting the calculated graphical information on the part of the road course ahead not captured by the camera via a projector onto a transparent plane starting from the end of the road ahead not captured by the camera.
determining whether the part of the road course ahead not captured by the camera includes a cause of danger; and
providing an alarm to the driver in case a cause of danger is determined.

12. A non-transitory data carrier comprising instructions for a processing system, which, when executed by the processing system, cause the computer to perform the computer implemented method of claim 11.

13. A processing system comprising the data carrier of claim 12.

14. The processing system of claim 13, wherein the processing system comprises an Application-Specific Integrated Circuit, ASIC, a Field-programmable gate array, FPGA, or a general purpose computer.

15. A vehicle comprising the head-up display system of claim 1.

16. A vehicle comprising the processing system of claim 13.
